(19) United States
(12) Patent Application Publication
(10) Pub. No.: US 2004/0146760 A1
(43) Pub. Date: Jul. 29, 2004

(54) Hydrogen supply unit

(75) Inventor: Kazuya Miwa, Wako-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Honda Motor Co., LTD.

(21) Appl. No.: 10/759,102

(22) Filed: Jan. 20, 2004

(30) Foreign Application Priority Data
Jan. 21, 2003 (JP) 2003-12455

(51) Int. Cl. H01M 8/06

(52) U.S. Cl. 429/19

(57) ABSTRACT

A hydrogen supply unit which generates electric power by use of a fuel cell and concurrently generates hydrogen, taking as its object the efficient generation of hydrogen from a source gas. The hydrogen supply unit 1 comprises a reformer 2 for reforming natural gas, a fuel cell 3 for generating electric power by use of the reformed gas from the reformer 2, and a purifier 4 for purifying hydrogen from the exhaust gas discharged from the fuel cell 3. The purifier 4 comprises a PEM 9 for conducting purification on the basis of the membrane separation method, and a PSA 11 for conducting purification by use of the pressure swing adsorption method. In the present invention, the reformed gas from the reformer 2 is used, without being subjected to purification, for the electric power generation in the fuel cell 3, and the purifier 4 purifies hydrogen from the exhaust gas discharged from the fuel cell 3. The offgas from the PEM 9 is used in a heater 8, and the offgas from the PSA 11 is used in the fuel cell 3. Consequently, the amount of the hydrogen burnt in the heater 8 is reduced as compared to the prior art, and hence the electric power generation and the hydrogen generation can be performed by using more efficiently the hydrogen contained in the source gas.

### BACKGROUND OF THE INVENTION

1. Field of the Invention

The present invention relates to a hydrogen supply unit which reforms a source gas such as natural gas, purifies hydrogen, and generates electric power with the aid of a fuel cell, at homes and fuel stations.

2. Description of the Related Art

In these years, it has been considered that electric power is generated by use of fuel cells in ordinary homes to supply electric power to electric appliances used in homes. Also in these years, efforts have been continued to popularize the use of automobiles which are each made to run by driving a motor by use of the electric power generated with the aid of a fuel cell (hereinafter referred to as “fuel-cell vehicles”). For the use of these fuel cells, a problem how hydrogen gas is supplied as fuel is raised; there is urgent demand for establishing somehow hydrogen stations like current gas stations.

As a conventional hydrogen supply unit 31, the unit disclosed in Japanese Patent Laid-Open No. 5-182683 has been known. As illustrated in FIG. 4 in a simplified manner, the hydrogen supply unit 31 comprises a reformer 32 for reforming a source gas such as city gas, a purifier 33 for purifying hydrogen from the reformed gas reformed by the reformer 32, a fuel cell 34 for generating electric power by use of the purified hydrogen, and a storage tank 35 for storing the hydrogen purified by the purifier 33 and the hydrogen which has not been used in the fuel cell 34. Incidentally, in FIG. 4, the device denoted by reference numeral 36 is a blower for taking out the exhaust gas from the fuel cell 34. Additionally, the electric power generated by the fuel cell 34 is stored in a battery 37 and is also used in the purifier 33 and the like.

The reformer 32 reforms a source gas by heating the source gas, and comprises a heater 38 for that purpose. On the other hand, the offgas from the purifier 33 contains hydrogen in addition to carbon monoxide, so that the offgas can be used as fuel. Accordingly, the conventional hydrogen supply unit 31 reforms the source gas by burning the offgas from the purifier 33 in the heater 38 as an auxiliary fuel. Incidentally, when a sufficient heat cannot be obtained only from the offgas from the purifier 33 in the heater 38, the source gas as obtained is supplied to the heater 38 (not illustrated in the figure).

As described above, the conventional hydrogen supply unit 31 uses the offgas from the purifier 33 as the auxiliary fuel for the heater 38, and hence can suppress the waste of the source gas; however, there remains a considerable amount of hydrogen in the offgas. Consequently, a unit has hitherto been demanded in which hydrogen can be generated from the source gas further efficiently.

The present invention takes as its object an improvement of the hydrogen supply unit, more specifically, the provision of a hydrogen supply unit which can generate hydrogen efficiently from a source gas, for the purpose of overcoming the disadvantages.

### SUMMARY OF THE INVENTION

The hydrogen supply unit of the present invention is characterized in that the hydrogen supply unit comprises, for the purpose of achieving the object, reformation means for reforming a source gas containing hydrocarbons to produce a hydrogen-rich reformed gas, a fuel cell for generating electric power by use of the reformed gas, and purification means for purifying hydrogen from the exhaust gas discharged from the fuel cell.

The hydrogen supply unit of the present invention generates electric power with the aid of the fuel cell by using the reformed gas reformed by the reformation means, and thereafter purifies hydrogen, with the aid of the purification means, from the exhaust gas from the fuel cell. In other words, in contrast to the conventional method in which hydrogen is purified, with the aid of purification means, from the reformed gas obtained from reformation means, and electric power is generated with the aid of a fuel cell by using the purified hydrogen, the hydrogen supply unit of the present invention generates electric power by using the reformed gas and thereafter purifies hydrogen from the exhaust gas discharged from the fuel cell. In this way, by purifying the exhaust gas from the fuel cell with the aid of the purification means, the amount of the offgas discharged from the purification means can be reduced. According to the experiment carried out by the present inventors, the hydrogen supply unit of the present invention can efficiently generate hydrogen from a source gas, and hence even when the same amount of the source gas is used as in a conventional unit to generate the same amount of electric power as in the conventional unit, the amount of storable hydrogen is increased to a large extent as compared to the conventional unit.

In the hydrogen supply unit of the present invention, it is preferable that the purification means conducts purification of hydrogen by means of the membrane separation method based on a hydrogen permeable membrane and the pressure swing adsorption method. The membrane separation method can efficiently separate CO₂ and the like from the source gas, but cannot remove the moisture. Accordingly, the moisture is removed by means of the pressure swing adsorption method which can remove moisture efficiently. Incidentally, the membrane separation method based on the hydrogen permeable membrane is referred to as the PEM (Proton Exchange Membrane) purification, and the pressure swing adsorption method is generally refereed to as PSA (Pressure Swing Adsorption), both being well known as the hydrogen purification methods.

More specifically, the purification means conducts purification by use of a membrane separator for carrying out membrane separation based on a hydrogen permeable membrane, a pressurizer for use in purification for pressurizing the gas purified by use of the membrane separator, and an adsorber for purifying the gas pressurized by the pressurizer for use in purification on the basis of the pressure swing adsorption method. In the purification means, by providing the membrane separator with hydrogen pressurizing function, the pressurizer for use in purification, downstream of the separator, may be made unnecessary. The adsorber for conducting the pressure swing adsorption method comprises a plurality of containers charged with an adsorbent, and purifies hydrogen by making the gas to be purified pass through the plurality of containers while varying the pressure of the gas to be purified.

It is preferable that the membrane separator for conducting the membrane separation method in the purification means separates the hydrogen by providing electrodes respectively on both surfaces of the hydrogen permeable membrane, and thus producing an electric potential difference between the front and back surfaces of the hydrogen permeable membrane to make the hydrogen ions permeate the membrane. The hydrogen permeable membrane can be made to permeate hydrogen by applying a pressure even when the electric potential difference between the front and back surfaces of the membrane is absent; however, a further fast permeation of hydrogen can be performed by making the hydrogen ions permeate the membrane by the application of the electric potential difference.

When in the hydrogen supply unit of the present invention, by heating with the aid of heating means using the source gas as fuel, the reformation means reforms the source gas, it is preferable that the offgas separated by the membrane separation method is used, when reforming, as the fuel for the heating means, in addition to the source gas, and the fuel cell generates electric power by use of the offgas separated by the pressure swing adsorption method, in addition to the reformed gas. The offgas separated by the membrane separation method contains such components that can be used as fuel, including carbon monoxide, hydrogen and the like, and hence, by burning the offgas in the heating means, the source gas can be used without waste. Additionally, the offgas separated by the pressure swing adsorption method contains only hydrogen and moisture, and is highly pure in hydrogen; accordingly, by supplying the offgas to the fuel cell, the hydrogen contained in the source gas can be used more efficiently for generation of electric power.

More specifically, it is preferable that the reformation means, by heating with the aid of the heater using the source gas as fuel, reforms the source gas, the offgas separated from the membrane separator is used, when reforming, as the fuel for the heater, in addition to the source gas, and the fuel cell generates electric power by using the offgas separated by the adsorber in addition to the reformed gas.

The hydrogen supply unit of the present invention may supply the hydrogen purified by the purification means directly to a vehicle that uses hydrogen, and may also comprise a storage means for storing the hydrogen purified by the purification means. It is preferable that the storage means comprises pressurization means for use in storage for pressurizing the hydrogen gas to be stored and connection means for being connected to a vehicle that uses hydrogen. When hydrogen is supplied to the vehicle, it is desirable that the hydrogen is rapidly transferred from the storage means to the vehicle; the storage means comprises the pressurization means for use in storage, so that the storage means can rapidly transfer the hydrogen by pressurizing the hydrogen.

More specifically, the hydrogen supply unit of the present invention comprises the storage means for storing the hydrogen purified by the purification means, the storage means comprises a first tank for storing the gas supplied from the adsorber, a pressurizer for use in storage for pressurizing the gas supplied from the first tank, a second tank for storing the gas supplied from the pressurizer for use in storage, and a connector for connecting the second tank to a vehicle that uses hydrogen as fuel.

### BRIEF DESCRIPTION OF THE DRAWINGS

FIG. 1 is a block diagram illustrating the configuration of the hydrogen supply unit of the present embodiment;

FIG. 2 is a figure illustrating the important part in the PEM purification; and

FIG. 3 is a block diagram illustrating the purification device of another embodiment of the present invention.

### DETAILED DESCRIPTION OF THE PREFERRED EMBODIMENTS

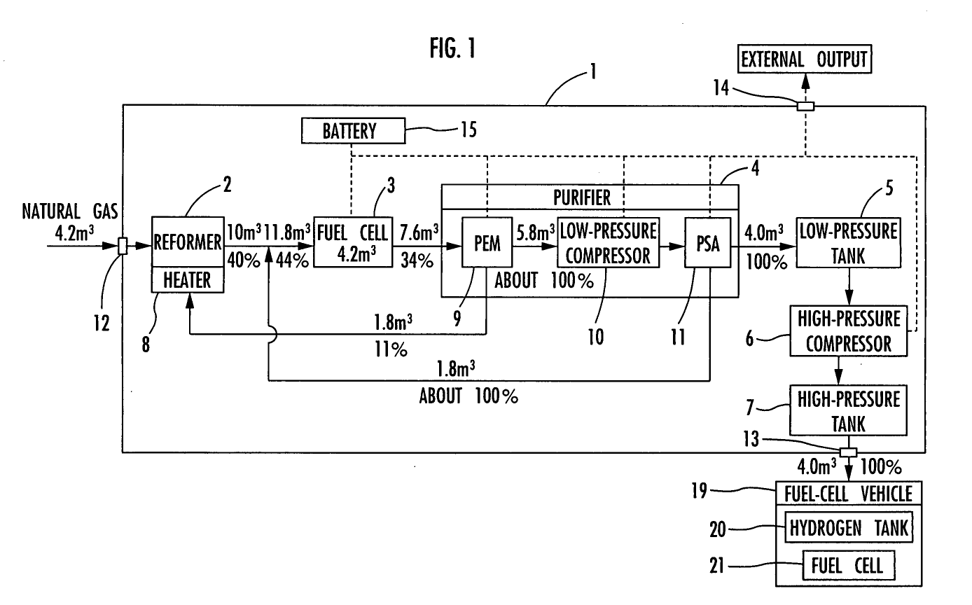

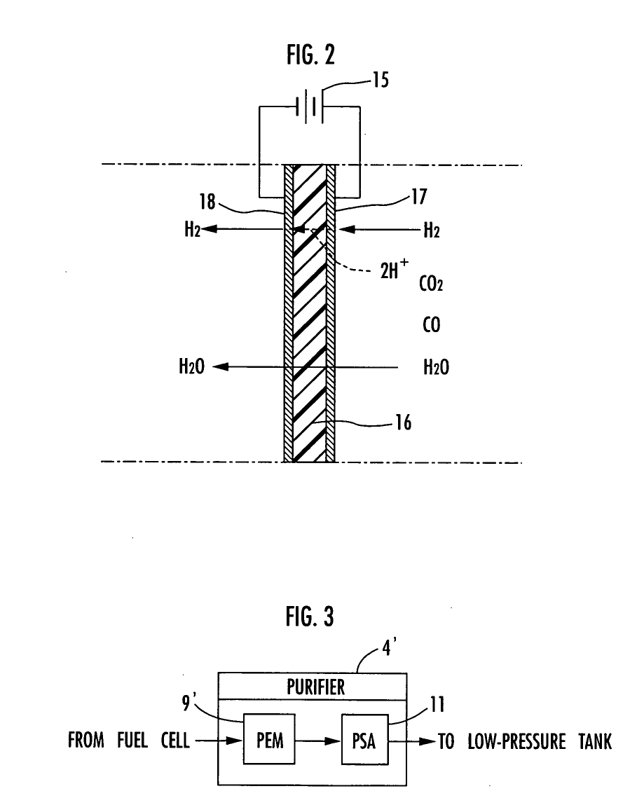

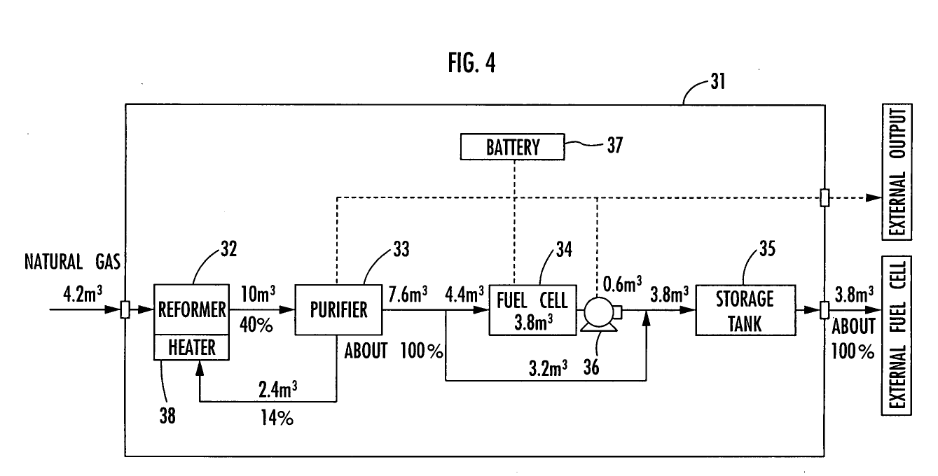

Description will be made below on one example of the embodiments of the hydrogen supply unit of the present invention with reference to FIGS. 1 to 3. FIG. 1 is a block diagram illustrating the configuration of the hydrogen supply unit of the present embodiment, FIG. 2 is a figure illustrating the important part in the PEM purification, and FIG. 3 is a block diagram illustrating the purification device of another embodiment of the present invention.

The hydrogen supply unit 1 of the present embodiment generates electric power in homes by utilizing city gas, supplies electric power to the electric appliances in homes, and also generates hydrogen to be supplied to fuel-cell vehicles 19 described below. The hydrogen supply unit 1, as FIG. 1 shows, comprises a reformer 2 for reforming natural gas as a source gas, a fuel cell 3 for generating electric power by using the reformed gas transferred from the reformer 2, a purifier 4 for purifying the hydrogen transferred from the fuel cell 3, a low pressure tank 5 (a first tank) connected to the purifier 4, a high pressure compressor 6 (a pressurizer for use in storage), and a high pressure tank 7 (a second tank).

Additionally, the reformer 2 comprises a heater 8. The purifier 4 comprises a PEM 9 (a membrane separator) for conducting membrane separation with the aid of a hydrogen permeable membrane 16, a low-pressure compressor 10 (a pressurizer for use in purification) for compressing at a low pressure (about 0.7 MPa) the hydrogen gas from the PEM 9, and a PSA 11 (an adsorber) for purifying the hydrogen gas from the low-pressure compressor 10 by means of the pressure swing adsorption method.

Additionally, the hydrogen supply unit 1 comprises a connector 12 connected to a gas pipe, not shown in the figure, for supplying natural gas, a connector 13 connected to a fuel-cell vehicle 19, and a connector 14 for externally transmitting the electric power generated by the fuel cell 3. In FIG. 1, the path for the electric power generated by the fuel cell 3 is shown by dotted lines. The electric power generated by the fuel cell 3 is stored in a battery 15, and is also supplied to the PEM 9, the low-pressure compressor 10, the PSA 11 and a high-pressure compressor 6, and moreover output from a connector 14 for use in external electric appliances.

The PEM 9 in the present embodiment comprises, as FIG. 2 shows, a hydrogen permeable membrane 16, and an anode plate 17 and a cathode plate 18 respectively fixed onto the two surfaces of the membrane 16. A voltage is applied from the battery 15 to the two electrodes. The hydrogen permeable membrane 16 has a characteristic to allow hydrogen ions (protons) to pass therethrough. In the present embodiment, for the hydrogen permeable membrane, a fluorocarbon ion exchange resin such as Nafion obtained from Du Pont Corp. coated with a catalyst is used. The anode plate 17 and the cathode plate 18 are each made of a porous sheet-like conductive material. In the present embodiment, a porous carbon paper is used.

The PSA 11 of the present embodiment comprises a plurality of adsorption chambers (not shown in the figure) charged with an adsorbent such as activated carbon. To the plurality of adsorption chambers, hydrogen gas is supplied from the low-pressure compressor 10, and hydrogen is purified by being subjected to adsorption, depressurization, cleaning and pressurization.

A fuel-cell vehicle 19 comprises, as FIG. 1 shows, a hydrogen tank 20 and a fuel cell 21; the fuel cell 21 generates electric power by using the hydrogen as fuel stored in the hydrogen tank 20, and the vehicle 19 is made to run by driving a motor, not shown in the figure, by use of the electric power thus generated. Incidentally, here is omitted the detailed description on the reformer 2, the fuel cell 3 and the like because these devices are similar in configuration to those conventionally used.

Now, description will be made on the operation of the hydrogen supply unit 1 of the present invention with reference to FIG. 1. At the beginning, natural gas as the source gas is supplied from a gas pipe, not shown in the figure, connected to the connector 12, and the natural gas is reformed by the reformer 2. Here, the natural gas, as indicated in FIG. 1, is supplied at a rate of 4.2 m³ per hour. Here, it should be noted that in the present embodiment, “m³”, indicating the gas volume is defined to denote the volume per one hour.

In the reformer 2, the natural gas, water from a water supply source, not shown in the figure, and the air (oxygen in the air) are allowed to react with each other to generate a hydrogen-rich reformed gas containing a large amount of hydrogen. The amount of the reformed gas generated by the reformer 2 is about 10.0 m³ and the hydrogen concentration in the reformed gas is about 40%. This reformed gas contains, in addition to hydrogen, carbon monoxide, carbon dioxide, nitrogen, unreacted natural gas and moisture. To this reformed gas, the below described offgas from the PSA 11 is added in an amount of about 1.8 m³ (with the hydrogen concentration of about 100%), and thus about 11.8 m³ of gas (with the hydrogen concentration of about 44%) is supplied to the fuel cell 3.

The fuel cell 3 generates electric power by using as fuel the supplied hydrogen containing gas. In this case, the fuel cell 3 consumes about 4.2 m³ of hydrogen. The exhaust gas discharged from the fuel cell 3 is about 7.6 m³ and about 34% in the hydrogen content ratio.

Then, the purifier 4 purifies hydrogen from the exhaust gas discharged from the fuel cell 3. Specifically, the PEM 9 generates about 5.8 m³ of purified hydrogen with the hydrogen concentration of about 100%. In this case, the purified gas also contains moisture. Now, description will be made below on the purification of hydrogen by means of the PEM 9 with reference to FIG. 2. In the PEM 9, a voltage is supplied between the anode plate 17 and the cathode plate 18 to yield an electric potential difference between the front and back surfaces of the hydrogen permeable membrane 16.

When the reformed gas is supplied from the reformer 2 under the conditions, the hydrogen gas releases electrons on the anode plate 17 to be converted to hydrogen ions, and the released electrons are made to transfer to the cathode plate 18 through the intermediary of the battery 15. The hydrogen ions pass through the hydrogen permeable membrane 16, contact the cathode plate 18 and receive electrons from the cathode plate 18 to be converted into hydrogen gas. In this way, in the PEM 9, hydrogen is purified from the reformed gas, and the moisture is also led downstream by passing through both electrodes 17, 18 and the hydrogen permeable membrane 16. The offgas from the PEM 9 contains, in addition to hydrogen, carbon monoxide and unreacted natural gas, and hence the offgas is burnt in the heater 8 to be utilized for heating the reformer 2.

Then, the moisture containing hydrogen gas, compressed according to need with the aid of the low-pressure compressor 10, is transferred to the PSA 11, and the PSA 11 removes the moisture to further raise the purity of the hydrogen gas.

The hydrogen purified as described above by the PSA 11 is about 4.0 m³ as FIG. 1 shows and is stored once in the low-pressure tank 5. When the amount of the hydrogen gas exceeds the storage capacity of the low-pressure tank 5, the excessive amount of the hydrogen is transferred to the high-pressure compressor 6 to be compressed (about 30 MPa) and stored in the high-pressure tank 7. When hydrogen is supplied to a fuel-cell vehicle 19, high-pressure hydrogen is supplied through the connector 13 from the high-pressure tank 7 to the hydrogen tank 20 of the fuel-cell vehicle 19.

In this connection, for the purpose of compressing the hydrogen gas with the aid of the high-pressure compressor 6, it is necessary to sufficiently remove the moisture by means of the PSA 11. If humid hydrogen gas is compressed at a high pressure, a large amount of drain water is generated to lead to various adverse effects including the water lock of the cylinder (not shown in the figure) in the high-pressure compressor 6, and the corrosion in the high-pressure tank 7 and the like. The dew point of the hydrogen gas after having been purified by the PSA 11 depends on the conditions of the compression conducted by the high-pressure compressor 6, and is desirably −30° C. or below under the atmospheric pressure.

In the PSA 11 only hydrogen is purified from the moisture containing hydrogen gas, but the offgas from the PSA 11 also contains about 1.8 m³ of hydrogen in addition to the moisture. In the present embodiment, the hydrogen contained in the offgas from PSA 11 is used as the fuel for the fuel cell 3.

As described above, the hydrogen supply unit 1 of the present embodiment can eventually generate 4.0 m³ of hydrogen from 4.2 m³ of natural gas.

Now, as a comparative example, description will be made on an example of the prior art, illustrated in FIG. 4, that uses 4.2 m³ of hydrogen, in the same manner as that in the present embodiment, and generates in a fuel cell 34 the same amount of electric power as that in the present embodiment. In the example of the prior art illustrated in FIG. 4, the purification of hydrogen is performed exclusively in the purifier 33, and accordingly a storage tank 35 is designed to store 3.8 m³ of hydrogen gas. However, the hydrogen gas having passed through the fuel cell 34 inevitably contains moisture, so that a dry hydrogen gas suitable for compression by means of a high-pressure compressor cannot be obtained as far as only the purifier 33 is used. In the circumstances, when there is added the condition that the moisture in hydrogen gas is removed by the purification based on a PSA, similarly to the present embodiment, the amount of the generated hydrogen becomes about 2.6 m³.

The fuel cell 3 of the present embodiment and the fuel cell 34 in the comparative example are made to generate the same amount of electric power, but the amount of the hydrogen consumed in the fuel cell 3 of the present embodiment is 4.2 m³, whereas the amount of the hydrogen consumed in the fuel cell 34 of the comparative example is 3.8 m³. This is probably because in the present embodiment, electric power generation is conducted not by use of hydrogen purified to 100% by the fuel cell but by use of a hydrogen-rich gas reformed by the reformer 2, and consequently the electric power generation efficiency in the fuel cell 3 as a single device is probably lowered.

However, in the present embodiment, hydrogen is purified by means of PEM 9 from the exhaust gas obtained after the electric power has been generated in the fuel cell 3, the offgas from this purification process is supplied to the heater 8, and the offgas from the PSA 11 is supplied to the fuel cell 3 to generate electric power. Thus, of the total amount of the source gas, the amount of the offgas burnt in the heater 38 in the comparative example is 2.4 m³, but the amount of the offgas burnt in the heater 8 in the present embodiment is as small as 1.8 m³. In the present embodiment, as described above, the hydrogen content in the source gas is efficiently used, and hence the utilization ratio of hydrogen as the whole system is improved.

Accordingly, as a result of comparison between the two cases under the condition that the same amount of the source gas is used and the same amount of electric power is generated in each of the fuel cells 3 and 34, it has been revealed that the prior art example yields about 2.6 m³ of storable hydrogen, while the present embodiment yields 4.0 m³ of storable hydrogen, achieving an improvement to a large extent.

Now, description will be made below on another embodiment of the present invention with reference to FIG. 3. In this embodiment, when hydrogen gas is compressed in a purifier 4′, the low-pressure compressor 10 is not used, but the compression is conducted by means of a PEM 9′ provided with a function for compressing hydrogen. In the purifier 4′, the voltage supplied from the battery 15 to the PEM 9′ is made higher than the voltage supplied to the PEM 9 of the embodiment. In the PEM 9′, in response to the electric energy increment of the PEM 9′, pressure can be applied to the hydrogen gas having permeated the hydrogen permeable membrane 16. In this way, a scheme, in which the PEM 9′ applies pressure to the hydrogen gas, is free from mechanical loss as seen in a usual compressor, so that the pressure of the hydrogen gas can be efficiently raised.

Incidentally, in the present embodiment, description has been made on the case in which electric power is generated by means of the fuel cell 3 in homes by using city gas as the source gas and hydrogen is supplied to a fuel-cell vehicle 19, but without being limited by this case, the present invention may be applied to a hydrogen station which supplies hydrogen, similarly to current gas stations, to fuel-cell vehicles 19 and hydrogen vehicles each provided with an internal combustion engine using hydrogen as fuel.

Additionally, in the present embodiment, hydrogen is once stored in the low-pressure tank 5 and in the high-pressure tank 7, but without being limited by this case, the hydrogen gas from the PSA 11 may be compressed by means of the high-pressure compressor 6 to be directly supplied to the hydrogen tank 20 of the fuel-cell vehicle 19.

Additionally, in the present embodiment, because description has been made on a unit for supplying hydrogen to the fuel-cell vehicle 19, hydrogen gas is raised in purity by means of the PSA 11 and stored in the high-pressure tank 7. However, when hydrogen is supplied for use in electric power generation at a stationary facility, the hydrogen purified by PEM 9 may be stored in the low-pressure tank 5. In this case, the PSA 11, the high-pressure compressor 6 and the high-pressure tank 7 become unnecessary.

Additionally, in the present embodiment, a fluorocarbon ion exchange resin is used as the hydrogen permeable membrane 16 in the PEM 9, but without being limited by this case, another membrane well known in the art that can permeate hydrogen gas and hydrogen ions may be used. Additionally, a porous carbon paper is used as the anode plate 17 and the cathode plate 18, but without being limited by this case, there may be used techniques well known in the art including a technique in which the hydrogen permeable membrane 16 is deposited on both surfaces thereof with metal, the surfaces respectively serving as the electrodes.

What is claimed is:

1. A hydrogen supply unit comprising:
reformation means for reforming a source gas containing hydrocarbons to generate a hydrogen-rich reformed gas;
a fuel cell for generating electric power by use of said reformed gas; and
purification means for purifying hydrogen from the exhaust gas discharged from said fuel cell.

2. The hydrogen supply unit according to claim 1, wherein said purification means conducts purification of hydrogen by use of the membrane separation method based on a hydrogen permeable membrane and by use of the pressure swing adsorption method.

3. The hydrogen supply unit according to claim 1, wherein said purification means comprises:
a membrane separator for conducting membrane separation based on a hydrogen permeable membrane;
a pressurizer for use in purification for pressurizing the gas purified by said membrane separator; and
an adsorber for purifying the gas pressurized by said pressurizer for use in purification by use of the pressure swing adsorption method.

4. The hydrogen supply unit according to claim 1, wherein said purification means comprises:
a membrane separator for conducting membrane separation based on a hydrogen permeable membrane provided with a function for pressurizing hydrogen; and
an adsorber for purifying, by use of the pressure swing adsorption method, the gas pressurized by said membrane separator.

5. The hydrogen supply unit according to any one of claims 2, 3, and 4, wherein the membrane separator for conducting the membrane separation method in said purification means comprises electrodes respectively on both surfaces of said hydrogen permeable membrane, and conducts the separation of hydrogen by providing an electrical potential difference between the front and back surfaces of said hydrogen permeable membrane to make hydrogen ions permeate said membrane.

6. The hydrogen supply unit according to any one of claims 2, 3, and 4, wherein the adsorber for conducting said pressure swing adsorption method is provided with a plurality of containers charged with an adsorbent, and purifies hydrogen by making the gas to be purified pass through the plurality of containers while varying the pressure of the gas being purified.

7. The hydrogen supply unit according to claim 2, wherein said reformation means reforms, by heating with the aid of heating means that uses the source gas as fuel, said source gas, and uses when reforming, as the fuel for said heating means, the offgas separated by said membrane separation method, in addition to said source gas; and said fuel cell generates electric power by using the offgas, separated by said pressure swing adsorption method, in addition to said reformed gas.

8. The hydrogen supply unit according to claim 3 or 4, wherein said reformation means reforms, by heating with the aid of the heater that uses the source gas as fuel, said source gas, and uses when reforming, as the fuel for said heater, the offgas separated by said membrane separator, in addition to said source gas; and said fuel cell generates electric power by using the offgas separated by said adsorber, in addition to said reformed gas.

9. The hydrogen supply unit according to any one of claims 1 to 8, comprising storage means for storing the hydrogen purified by said purification means.

10. The hydrogen supply unit according to claim 9, wherein said storage means comprises:
a pressurization means for use in storage for pressurizing the hydrogen gas to be stored, and
connection means for being connected to a vehicle that uses hydrogen as fuel.

11. The hydrogen supply unit according to any one of claims 3, 4 and 7, comprising storage means for storing the hydrogen purified by said purification means, wherein said storage means comprises:
a first tank for storing the gas supplied from said adsorber;
a pressurizer for use in storage for pressurizing the gas supplied from said first tank;
a second tank for storing the gas supplied from said pressurizer for use in storage; and
a connector for connecting said second tank to a vehicle that uses hydrogen as fuel.
